(19) United States
(12) Patent Application Publication
(10) Pub. No.: US 2010/0192433 A1
(43) Pub. Date: Aug. 5, 2010

(54) CODED MESSAGE CLOTHING AND SYSTEM THEREOF

(76) Inventor: Robert Lewis, Hoschton, GA (US)

Correspondence Address: Innovative IP, PLC, P.O. Box 217, New Smyrna Beach, FL, 32170, US

(21) Appl. No.: 12/364,898

(22) Filed: Feb. 3, 2009

(51) Int. Cl. G09F 21/02; H04L 9/00

(52) U.S. Cl. 40/586; 380/59

(57) ABSTRACT

Coded message clothing and a system thereof wherein theme-based, numerical coding is displayed on a wearable article, and wherein associated theme-based code books are offered therewith, such that only a purchaser of a coded article within a particular theme may receive the related translation book for that theme, and therefore decode a message related to that theme, wherein only purchasers of commonly themed articles may translate each other's messages.

### FIELD

The present disclosure relates generally to message systems, and more particularly, to a system and method for defining and displaying coded messages on clothing and accessories.

### BACKGROUND

T-shirts have become well-recognized as a useful medium for delivering messages. Words and images are prominently displayed and delivered to an ever-changing public as the wearer travels through his or her day, effortlessly communicating a message. Some such messages, for example, deliver a humorous quip, indicating the sense of humor of the wearer; others display a graphic image or photograph, frequently representative of activities or individuals that are important to the wearer. Still others communicate allegiance to a particular trademark brand, sports team, musical performer, or the like; and further others function to convey a political, social belief, club membership, or other target message. Each is generally selected by the wearer upon approval of overall style, as well as agreement and/or comfort with the message.

In this final respect, however, it is noted that many individuals might support or agree with a particular perspective, and might desire to communicate a message related thereto, but may hesitate to openly display this position to the general public. That is, an individual may desire to limit communications to only those in general agreement or otherwise supportive of the same position, for fear of negative feedback or judgment. In such case, it would be desirable to be able to communicate in visual code.

One example of clothing that delivers coded messages is swimwear with nautical flag display imprints. At first glance, a viewer is not necessarily able to understand the message, but only to observe its presence. Such a display manner may serve to increase interest in the message, wherein only those viewers that are familiar with the well-known nautical flag system can understand the true message content. Additional viewers, however, may utilize readily available reference materials to determine the meaning of the flag message, as desired, and therefore such a coded system for clothing is disadvantageously readily translatable.

Another example of clothing that delivers coded messages involves a system of letters, wherein an artistic grouping of letters actually communicates a message, and wherein the related message may be translated via unrestricted access to an online translator. Such a system may also serve to create additional intrigue, but, as with the flags, remains readily translatable by any viewer, and as such, is disadvantageous in view of the present disclosure.

Therefore, it is readily apparent that there is a need for a system and method for delivering coded messages via clothing in such a manner that access to code translation materials is controlled, thereby preventing general translation, and thereby avoiding the above-discussed disadvantages.

### BRIEF SUMMARY

Briefly described, in a preferred embodiment, the present device, and system thereof, overcomes the above-mentioned disadvantages and meets the recognized need for such a system by providing coded message clothing and a system thereof, wherein theme-based, numerical coding is displayed on a wearable article, and wherein associated theme-based code books are offered therewith, such that only a purchaser of a coded article within a particular theme may receive the related translation book for that theme, and therefore decode a message related to that theme, wherein only purchasers of commonly themed articles may translate each other's messages.

According to its major aspects and broadly stated, in its preferred form, the present invention is coded-message clothing and a system thereof, wherein an assortment of products are imprinted with a pair of two digit numerals, wherein each two digit numeral has a coded meaning, wherein each pair of two digit numerals further defines a phrase according to coded meaning, wherein the codes are organized according to a thematic structure, wherein the code book for each theme is unique, and wherein deciphering of coded messages is limited according to restricted access to the related theme code book.

More specifically, the coded message clothing and system thereof, in its preferred form, is a system for creating and displaying numerically coded messages on clothing and accessories, wherein a series of code books are relatedly provided for translation of the codes. That is, a variety of code books facilitate coded message translation according to message themes or subject matter content, such as, religion, sports, education, sexuality, or the like. In the preferred embodiment, the visual codes are displayed as a first two-digit number, a colon, and a second two-digit number, all in a vertical arrangement relative to the display orientation as viewed, such as on a shirt. A message decoder book is provided with each article, wherein the information therein facilitates translation of the code on that article, as well as the coded messages of other articles with similarly themed content. That is, for example, a code book related to an article with a religion-themed message would not enable translation of a sports-themed coded message, and vice versa. Thus, while each coded message is presented in a similarly formatted visual display, and may be recognized as a message according to the present system, the meaning of each message may only be known by those with expressed similar interest according to selection of coded article.

According to the preferred embodiment of the present system and device, visual intrigue may be developed upon general recognition of a coded message. Display of a coded message may further represent an exclusive membership, of sorts, wherein only those with coded articles may know their own message and may decode messages of other articles. Additionally, the existence of specialized subcategories further delineate the “membership,” according to theme, such that message meanings may only become known to those particular individual members of the same specialized, sub-categorical theme.

Thus, a feature and advantage of the present system and device is its ability to facilitate delivery of coded messages to a controlled audience.

Another feature and advantage of the present system and device is its ability to create user sub-groups, according to theme, wherein each user sub-group may translate each other's display messages.

Yet another feature and advantage of the present system and device is its ability to facilitate visual display of virtually any message on a bodyworn article, in any environment, and essentially without risk of repercussion.

Still another feature and advantage of the present system and device is its ability to not only prevent non-users from translating the coded messages, but to also prevent a first user group from translating the coded messages of a second user group.

Yet still another feature and advantage of the present system and device is its ability to create a recognizable image pattern, wherein the existence of a coded message may be readily identifiable.

Still yet another feature and advantage of the present system and device is its ability to stimulate curiosity regarding the meaning of the coded message.

Yet another feature and advantage of the present system and device is its ability to adapt to and communicate messages according to essentially any theme, thereby facilitating participation across all walks of life.

Yet still another feature and advantage of the present system and device is its ability to adapt for display on virtually any item.

These and other objects, features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1a is a front view of a coded message system, according to the preferred embodiment of the present disclosure, showing an article of clothing;

FIG. 1b is a perspective view of a coded message system, according to the preferred embodiment of the present disclosure, showing a code book;

FIG. 2 is a rear view of a coded message system, showing a t-shirt with a specific display design, according to the present disclosure, on the back thereof; and

FIG. 3 is a side view of a sock, according to the coded message system of the present disclosure.

### DETAILED DESCRIPTION OF THE PREFERRED AND ALTERNATE EMBODIMENTS

In describing the preferred and alternate embodiments, as illustrated in the figures and/or described herein, specific terminology is employed for the sake of clarity. The device and method thereof, however, are not intended to be limited to the specific terminology so selected, and it is to be understood that each specific element includes all technical equivalents that operate in a similar manner to accomplish similar functions.

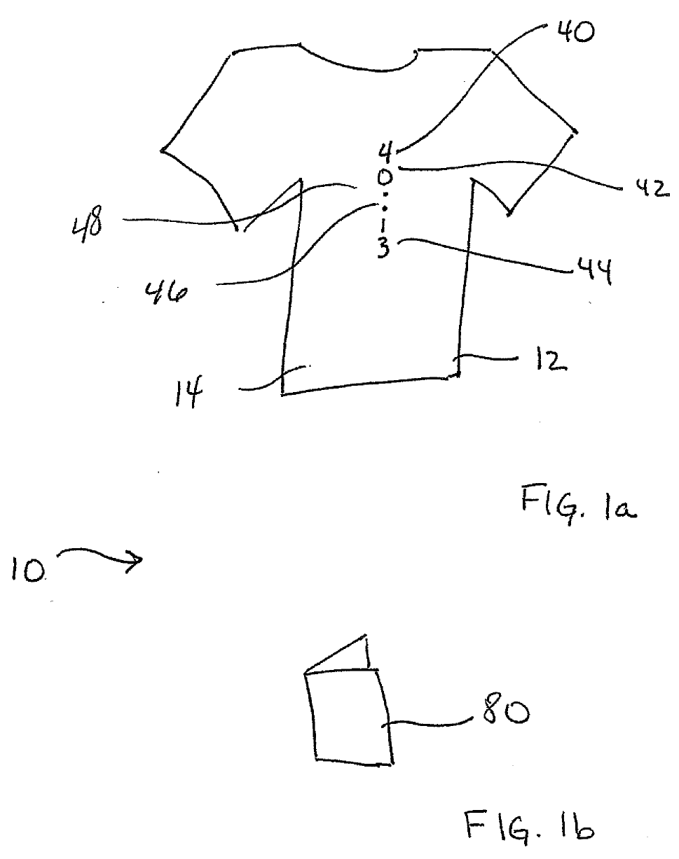

Referring now to FIGS. 1a-3, in the preferred embodiment, coded message clothing 10, and system thereof, comprises product 12 imprinted with message 40, and related code book 80. Message 40 is preferably defined by first two-digit numeral 42 and second two-digit numeral 44, with colon 46 therebetween. Thus, message 40 is preferably communicated via pair 48 of two digit numerals 42, 44, wherein each two digit numeral 42, 44 has a preferably unique coded meaning, and wherein each pair 48 of two digit numerals 42, 44 further defines a phrase according to a farther preferably unique coded meaning, as will be further discussed hereinbelow. In the preferred embodiment, as depicted in FIG. 1a, first two-digit number 42, colon 46, and second two-digit number 44 are displayed as visual codes in a vertical arrangement relative to the display orientation as viewed, such as on t-shirt 14. It should be noted, of course, that alternative arrangements for message 40 are contemplated, such as horizontal, diagonal, or otherwise as desired.

Preferably, a series of code books 80 are relatedly provided for enabling translation of the coded messages 40, wherein each code book 80 preferably facilitates coded message translation according to a specifically themed content. For example, message themes may preferably include such categorized content as religion, sports, education, sexuality, or the like. One skilled in the art would readily recognize that any desired theme could be selected for use, essentially without limitation, for definition and display according to the coded message system 10 of the present disclosure.

Preferably, one code book 80 is provided in combination with each coded message product 12, wherein the decoder content information therein facilitates translation of coded message 40 on that article or product 12, as well as coded messages 40 of other articles or products 12 that bear equivalently themed content. That is, for example, a purchaser of a t-shirt 14 bearing a coded message 40 relating to gay lifestyle would receive a code book 80 with decoder information for translating the particular coded message 40 on the purchased t-shirt, as well as other coded messages 40 relating to gay lifestyle. However, such a code book 80, according to the present example, would preferably not enable translating a coded message 40 relating to any other theme, such as, for example, sports, and vice versa.

Accordingly, while it is preferred that each coded message 40 of the present system 10 be created and displayed according to similar format, such that each coded message 40 may be generally recognized as a message according to the present system 10, the translated meaning of each message 40 may only be known by those with expressed similar interest according to selection and purchase of coded article 12 and related code book 80. It should be understood, therefore, that it is preferred that each pair 48 of two digit numerals 42, 44 may only be translatable according to one theme. In such manner, the inadvertent display of a non-selected message 40 may be prevented.

According to the preferred embodiment of the present system and device 10, visual intrigue may be developed upon general recognition of the visual display of coded message 40. Thus, wearable display of such a device 10 may serve to stimulate inquiry regarding the meaning. Display of coded message 40 may further represent an exclusive membership, of sorts, wherein only those with coded articles 12 may know their own message 40 and may decode messages 40 of other articles 12. That is, the existence of specialized subcategories, or themes, further delineates the general coded message product “membership” according to theme, because message meanings may only become known to those particular individual members of the same specialized, sub-categorical theme. In such manner, the opportunity for negative or judgmental reproach by a viewer to a wearer is essentially eliminated, because the meaning of the message remains protected and unknown relative to those uninvolved with a particular theme.

Thus, while the present system and device 10 is particularly suitable for use on t-shirt 14, visual display of virtually any message 40 may be accomplished on essentially any bodyworn article or personal or home accessory, such as, for exemplary purposes only, socks, pants, hats, underwear, belts, belt buckles, jackets, pocket books, luggage, head bands, wrist bands, bed linen, suits, dresses, and skirts, in any environment, and essentially without risk of repercussion, wherein one such exemplary embodiment is depicted in FIG. 3. Additionally, coded message 40 may be displayed in essentially any location on a given article. For example, on a t-shirt, message 40 could be on the front, the back, the side, or the sleeve, or any combination thereof.

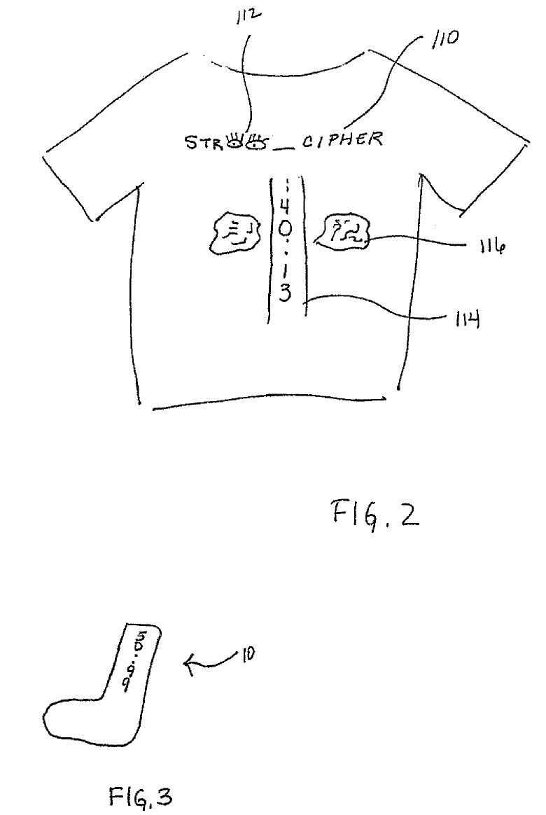

Referring now to FIG. 2, a complete visual display may further define message 40, as shown, wherein a recognizable word mark 110, preferably STREE_CIPHER, is positioned as a display header. Preferably, the double “e” in STREE is defined by a pair of eyes 112. Proximate thereto, street 114 is depicted, running through an opened brain 116. Coded message 40 may be displayed on street 114. Such an image and suggestive word mark serves to further enhance intrigue and interest regarding each message 40, and also serves to increase consumer recognition regarding the common source of the coded messages 40, even though the third party viewer of message 40 is generally unable to translate or understand the message, unless having previously purchased a similarly themed product 12.

As noted, a plurality of coded messages 40 may be created for each of a plurality of themes. By way of example, and not limitation, some exemplary themes and messages are included in the following table.

| CATEGORY | CODED MESSAGE | TRANSLATED MESSAGE |
|---|---|---|
| Religion | 1034 | God really love's you |
| Sports | 2080 | We are going to beat your team |
| Education | 3008 | I've got love for my school |
| Family | 4013 | Show your mom more love |
| Motivation | 5099 | When you learn, teach |
| Gay | 6002 | I love pretty gay women |
| Slang | 7123 | What's happening shortie |
| Sex | 8080 | I love my women with a tight butt |
| X games | 9921 | I want to see a half pike |

Each code book 80 is preferably numerically organized, wherein an index of code translations is provided therein. Alternate configurations for each code book 80 could comprise an electronic format, component or device. Additionally, indexed code translations preferably enable translation of each two digit component 42, 44, as well as the entire message 40, such that creative combination of two digit components 42, 44 could enable definition of further messages 40. Finally, while it is preferred that each coded message 40 for each particular theme bear a common first numeral for two digit component 42 in order to facilitate quick and easy recognition of the theme of a given message 40 to previous purchasers of that theme, it should be readily recognized that any type of pattern may alternately be utilized to enable viewer identification of the theme of the message being viewed. The indexed code translations could further alternately bear no such themedly-related commonality, such that identification of theme would be limited to only those previous purchasers of a product 12 with the exact same message 40.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

I claim:

1. A system for delivery of coded messages, comprising:
a first numerical code,
a first personal article, and
a first reference source,
wherein said first numerical code is displayed on said first personal article,
wherein said first numerical code defines a first translated message,
wherein said first translated message is an element of a first theme,
wherein said first reference source is only accessible via association with said first personal article,
wherein said first reference source is a decoder for said first numerical code.

2. The system for delivery of coded messages of claim 1, further comprising:
a second numerical code different from said first numerical code,
a second personal article, and
a second reference source the same as said first reference source,
wherein said second numerical code is displayed on said second personal article,
wherein said second numerical code defines a second translated message different from said first translated message,
wherein said second translated message is an element of said first theme,
wherein said second reference source is accessible via association with said second personal article and via association with said first personal article, and
wherein said second reference source is a decoder for said second numerical code and for said first numerical code.

3. The system of claim 2, wherein said first reference source and said second reference source are identical decoders for a plurality of said numerically coded messages, wherein each said numerically coded message of said plurality is an element of said first theme.

4. The system for delivery of coded messages of claim 1, further comprising:
a second numerical code different from said first numerical code,
a second personal article, and
a second reference source different from said first reference source,
wherein said second numerical code is displayed on said second personal article,
wherein said second numerical code defines a second translated message different from said first translated message,
wherein said second translated message is an element of said second theme different from said first theme,
wherein said second reference source is accessible only via association with said second personal article, and
wherein said second reference source is a decoder for said second numerical code.

5. The system of claim 4, wherein said first reference source and said second reference source are each decoders for a plurality of said numerical codes, wherein said plurality of numerical codes translatable by said first reference source are elements of said first theme,
wherein said elements of said first theme are translatable only by said first reference source,
wherein said plurality of numerical codes translatable by said second reference source are elements of said second theme, and
wherein said elements of said second theme are translatable only by said second reference source.

6. The system of claim 1, further comprising a plurality of said numerical codes, a plurality of personal articles and a plurality of reference sources,
wherein each said numerical code of said plurality is displayed on one said personal article of said plurality,
wherein each said numerical code of said plurality defines one of a plurality of translated messages,
wherein each said translated message of said plurality is an element of one of a plurality of themes,
wherein each said reference source of said plurality is associated with one said personal article of said plurality, and
wherein each said reference source of said plurality is a decoder for a plurality of numerical codes defining one of a plurality of messages of one said theme of said plurality of themes.

7. The system of claim 6, wherein said plurality of themes comprise religion, sports, education, sexuality, sexual orientation, family, motivation, slang, and X-GAMES.

8. The system of claim 1, wherein said first personal article is an article of clothing.

9. The system of claim 8, wherein said article of clothing is a t-shirt, and wherein said first numerical code is displayed in a position selected from the group consisting of the front, the back, the side, and the sleeve.

10. The system of claim 1, wherein said first reference source is a code book.

11. A device for visual communication of a coded message, comprising:
a wearable article having a first two digit number and a second two digit number visible thereon, said first two digit number and said second two digit number defining said coded message according to a selected subject matter; and
a code book for said wearable article, wherein said code book is adapted to decode said coded message visible on said wearable article,
wherein said code book is further adapted to decode other coded messages, but only according to said selected subject matter.

12. The device of claim 11, further comprising:
another wearable article having another first two digit number and another second two digit number visible thereon and defining another coded message according to another selected subject matter; and
another code book for said another wearable article, wherein said another code book is adapted to decode coded messages only according to said another selected subject matter.

13. The device of claim 11, wherein each number of said first two digit number and each number of said second two digit number are vertically arranged relative to each other and relative to a display orientation of said wearable article, and wherein a colon is displayed between said second number of said first two digit number and said first number of said second two digit number.

14. The device of claim 11, wherein said first two digit number defines a first word set of one or more words, wherein said second two digit number defines a second word set of one or more words, and wherein said first two digit number and second two digit number together define a third word set of one or more words.

15. A system of coded messaging, comprising:
a plurality of code translation sources, each said source adapted to translate a plurality of codes of a single theme of a plurality of themes; and
a plurality of personal articles, each said personal article having a set of four digits displayed thereon, each said set defining a coded message of a single theme of a plurality of themes,
wherein each said personal article is associated with one said code translation source of a common said theme of said plurality of themes, and
wherein each said coded message is translatable only by one said code translation source of a common said theme to that said coded message.

16. The system of coded messaging of claim 15, wherein said plurality of coded messages are defined according to an image pattern, and wherein said image pattern identifies existence of said coded message but does not enable decoding of said coded message without reference to said translation source.

17. The system of coded messaging of claim 15, wherein every said coded message of each said theme has a common first digit with every other said coded message of the same said theme, and a different first digit than every coded message of any other said theme.

18. The system of coded messaging of claim 15, wherein each said personal article of said plurality of personal articles is selected from the group consisting of a bodyworn article, a personal accessory, a home accessory, a shirt, a sock, a pair of pants, a hat, a pair of underwear, a belt, a belt buckle, a jacket, a pocket book, an article of luggage, a head band, a wrist band, an article of bed linen, a suit, a dress, and a skirt.

19. The system of claim 13, further comprising a display header above said vertically displayed numbers, wherein said numbers are displayed proximate an image of a street, and wherein an image of an opened brain surrounds said numbers.

20. The system of claim 13, wherein at least one of said plurality of code translation sources is electronic.
